(19) United States
(12) Patent Application Publication
(10) Pub. No.: US 2007/0145208 A1
(43) Pub. Date: Jun. 28, 2007

(54) Apparatus for visual display of greeting cards

(76) Inventor: Harry J. Beaver, Madison, AL (US)

Correspondence Address: LANIER FORD SHAVER & PAYNE, P O BOX 2087, HUNTSVILLE, AL, 35804, US

(21) Appl. No.: 11/644,191

(22) Filed: Dec. 22, 2006

Related U.S. Application Data
(60) Provisional application No. 60/754,402, filed on Dec. 28, 2005.

(51) Int. Cl. F16M 11/00

(52) U.S. Cl. 248/175

(57) ABSTRACT

An apparatus for the visual display of greeting cards, photographs, artwork, notes, or other items is provided. Such apparatus comprises a suspension member that is attached in one embodiment to a vertical support alternatively suited for either static display on a horizontal surface or for insertion into a semi-solid material, such as, dirt, potting soil or Styrofoam®. In other embodiments, the suspension member is attached to a base for attachment via magnetic force or adhesive to a vertical surface. Various embodiments of the present invention include alternative hanger means for securing the item to be displayed to the display apparatus, including a clip member or a bent-wire-type frame for simultaneously supporting the display item while being suspended from the suspension member.

### REFERENCE TO RELATED APPLICATIONS

This application claims priority to U.S. Provisional Patent Application Ser. No. 60/754,402, entitled “Apparatus for Visual Display of Greeting Cards” and filed on Dec. 28, 2005, which is fully incorporated herein by reference.

### FIELD OF THE INVENTION

This invention generally relates to an apparatus for the visual display of an object. In particular, the present invention relates to an apparatus for the visual display of greeting cards, photographs, artwork, notes or other items.

### BACKGROUND

It is a common practice to display greeting cards received in connection with a special event or holiday. In particular, the display of such cards has increased with the use of personalized cards having photographs of the sender and/or their family. Still further, the increasing popularity of scrap-booking has allowed practitioners to generate cards and displays of artistic merit that receivers often wish to display upon their receipt.

Several and various card display devices are known in the prior art, including several of the type requiring an adhesively bonded hook member attached to the card to be displayed, which in turn is attached to an elongated strip of mounting material. One disadvantage of this type of device is that the greeting card is often damaged when an attempt to remove the hook member is made.

Another known example of a greeting card display device includes a decorative wire-reinforced, vertically hung suspension apparatus having a plurality of friction-fit clips for receipt of a plurality of greeting cards. The apparatus is generally suspended on a wall or across an opening by its disparate ends. A similar but different type of greeting card display device includes the provision of clip members slidably mounted on an elongated strip, whereby items may be mounted at various locations along the length of the strip. In such a device, the clips are not detachable from the strip unless removed from the strip at either end thereof.

Finally, there is known in the prior art a card display device for the display of multiple greeting cards in a single display. Such device includes a hollow circular central core through which a cord is wrapped in successive loops. Cards to be displayed are inserted under a single one of the continuous loops so as to secure them in place about the central core. As with the above examples of prior art card display devices, this type of device generally lends itself solely to the display of multiple greeting cards, photographs, artwork, notes, or items. Further, the above-described prior art display devices are generally not considered aesthetically pleasing.

With the aforementioned display devices in mind, it is desirable to provide an apparatus for the visual display of a single greeting card, photograph, artwork, note or other item that is suited for alternatively displaying an item either suspended from a affixation means or supporting such item from below using a suspension means connected to but separate from the display apparatus. Further, it is desirable to provide an apparatus for the visual display of a greeting card in which such apparatus is alternatively suited for either a static display of such greeting card on a generally horizontal surface or in association with a grouping of flowers or a plant.

It is therefore a principle object of the subject invention to provide a visual display device suited for displaying greeting cards, photographs, artwork, notes, or other items. More particularly, it is an object of the present invention to provide an apparatus for the visual display of a greeting card wherein the apparatus is alternatively suited for a static display from a generally horizontal surface or in association with a grouping of flowers or a plant. In such context, it is still a more particular object of the present invention to provide an apparatus for the visual display of a greeting card or other visual material wherein the apparatus has either a support base or wherein it comprises a generally vertical lower section for insertion into a support media, such as dirt, planting soil or Styrofoam®.

It is another object of this invention to provide an apparatus for the visual display of a greeting card wherein the apparatus is suited for a static display from a generally vertical surface, such as a wall or refrigerator.

Still further, it is a principle object of this invention to provide an apparatus for the display of visual material wherein an embodiment of such display apparatus is suited for displaying an item suspended from an affixation means. In such context, it is an object of the present invention to provide such a display apparatus having a clip affixing such display item from above. In yet another embodiment of the present invention, such display apparatus is suited for supporting a display item using a suspension means connected to but separate from the display apparatus. In such context, it is an object of the present invention to provide such a display apparatus wherein such suspension means is a hanger member for supporting the displayed item and suited for suspension from the display apparatus.

Additional objects and advantages of the invention are set forth in, or will be apparent to those of ordinary skill in the art from, the detailed description as follows. Also, it should be further appreciated that modifications and variations to the specifically illustrated and discussed features and materials hereof may be practiced in various embodiments and uses of this invention without departing from the spirit and scope thereof, by virtue of present reference thereto. Such variations may include, but are not limited to, substitutions of the equivalent means, features, and materials for those shown or discussed, and the functional or positional reversal of various parts, features, or the like.

Still further, it is to be understood that different embodiments, as well as different presently preferred embodiments, of this invention, may include various combinations or configurations of presently disclosed features, elements, or their equivalents (including combinations of features or configurations thereof not expressly shown in the figures or stated in the detailed description).

These and other features, aspects and advantages of the present invention will become better understood with reference to the following descriptions and appended claims. The accompanying drawings, which are incorporated in and constitute a part of this specification, illustrate an embodiment of the invention and, together with the descriptions, serve to explain the principles of the invention.

### SUMMARY OF THE INVENTION

The present invention recognizes and addresses various of the foregoing limitations and drawbacks, and others, concerning prior art greeting card display devices. Therefore, the present invention is directed to an improved apparatus for the visual display of greeting cards, photographs, artwork, notes or other items.

In one exemplary embodiment, there may be provided an apparatus for the visual display of greeting cards, photographs, and/or artwork, notes, or other items. Such apparatus may comprise a generally vertical support having an upper end and a lower end. At the lower end of the vertical support may be located a support base of sufficient size and weight to provide static stability to the apparatus whether or not it is loaded with the weight of a displayed item. On the upper end, opposing the lower end of the vertical support, may be located a suspension member extending from the vertical support. A hanger means for securing the display item to the apparatus may be provided. In this exemplary embodiment, such hanger means may comprise a bent wire-frame suitable for supporting the display item while suspended from the suspension member.

In another exemplary embodiment, there may be provided an apparatus for the visual display of greeting cards, photographs, and/or artwork, notes, or other items. Such apparatus may comprise a generally vertical support having an upper end and a lower end. At the lower end of the vertical support may be located a support base configured to provide static stability to the apparatus whether or not it is loaded with the weight of a displayed item. On the upper end, opposing the lower end of the vertical support, may be located a suspension member extending generally perpendicular to the vertical support. A hanger means for securing the display item to the apparatus may be provided. In this exemplary embodiment, such hanger means may comprise a spring-loaded clip member for frictionally securing the display item. The clip member may be suspended from or integral with the suspension member.

In yet another exemplary embodiment in accordance with the present invention, there may be provided an apparatus for the visual display of greeting cards, photographs, and/or artwork, notes, or other items. Such apparatus may comprise a generally vertical support having an upper end and a lower end. The lower end of the vertical support may be suited for easier passage into a supporting media, such as dirt, potting soil, Styrofoam®, or other semi-solid material. On the upper end, opposing the lower end of the vertical support, a suspension member may extend generally perpendicularly to the vertical support. A hanger means for securing the display item to the apparatus may be provided. The hanger means may comprise a bent wire-frame suitable for supporting the display item suspended from the suspension member.

In another exemplary embodiment of the present invention, there may be provided an apparatus for the visual display of greeting cards, photographs, and/or artwork, notes, or other items. Such apparatus may comprise a generally vertical support having an upper end and a lower end. The lower end of the vertical support may be suited for easier passage into a supporting media, such as dirt, potting soil, Styrofoam®, or other semi-solid material. On the upper end of the vertical support may be located a suspension member extending generally perpendicular to the vertical support. A hanger means for securing the display item to the apparatus may be provided. In this exemplary embodiment, such hanger means may comprise a spring-loaded clip member for frictionally securing the display item. The clip member may be suspended from or integral with the suspension member.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of one embodiment of the present invention including a solid support base;

FIG. 2 is a perspective view of one embodiment of the invention in which the base, vertical support, and suspension member are comprised of one continuous bent wire.

FIG. 3 is a perspective view of an embodiment of the invention in which the lower end of the vertical support member is a stake.

FIG. 4 is a partial perspective view of a suspension member in which the free end of the suspension member comprises a looped wire.

FIG. 5 is a partial perspective view of a suspension member in which the free end of the suspension member comprises a downward hook.

FIG. 6 is a perspective view of one embodiment of the invention in which the hanger means is a bent-wire that supports the card from below.

FIG. 7 is a perspective view of one embodiment of the invention in which the hanger means supports a card over a horizontal support.

FIG. 8 is a perspective view of one embodiment of the invention showing a standard clip hangar means.

FIG. 9 is a perspective view of one embodiment of the invention showing a novel bent-wire hangar means.

FIG. 10 is an enlarged view of the bent-wire clip illustrated in FIG. 9.

FIG. 11 is top view of the novel bent wire clip illustrated in FIGS. 9 and 10.

FIG. 12 is a perspective view of an embodiment of the invention using a spirally-bent wire clip as the hanger means.

FIG. 13 is a side view of a base and suspension means suited for use with the display item attachment mechanisms described herein.

Repeated use of reference characters throughout the present specification and appended drawings is intended to represent the same or analogous features or elements of the invention.

### DETAILED DESCRIPTION OF THE PREFERRED EMBODIMENTS

Reference will now be made in detail to presently preferred embodiments of the invention, examples of which are fully represented in the accompanying drawings. Such examples are provided by way of an explanation of the invention, not limitation thereof. In fact, it will be apparent to those skilled in the art that various modifications and variations can be made in the present invention, without departing from the spirit and scope thereof. For instance, features illustrated or described as part of one embodiment can be used on another embodiment to yield a still further embodiment. Still further, variations in selection of materials and/or characteristics may be practiced, to satisfy particular desired user criteria. Thus, it is intended that the present invention cover such modifications and variations as come within the scope of the present features and their equivalents.

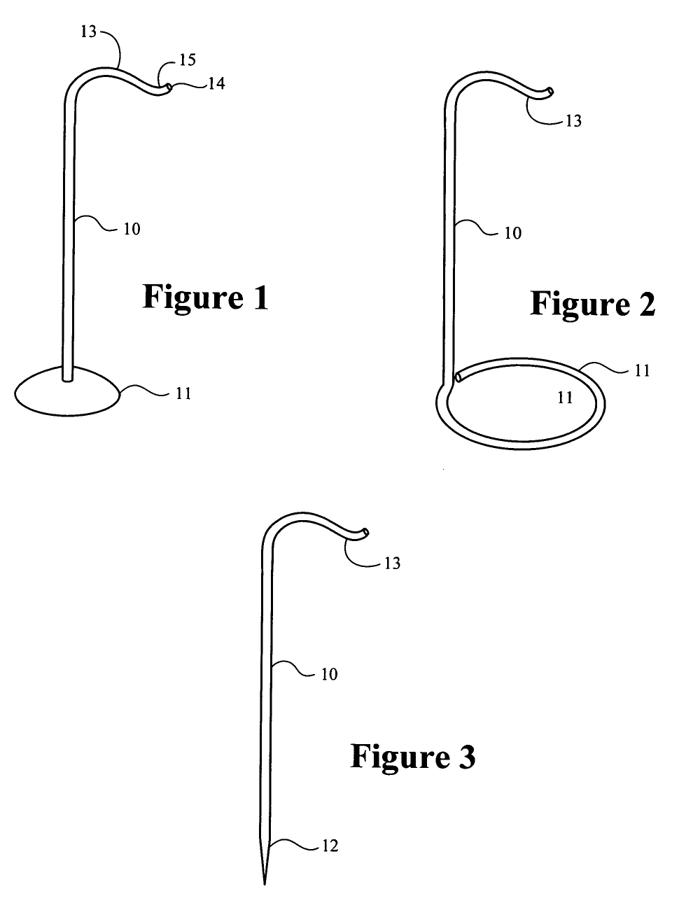

As disclosed above, the present invention is particularly concerned with an apparatus for the visual display of greeting cards, photographs, artwork, notes, or other items. As best seen in FIGS. 1 and 2, the present invention comprises a generally vertical support 10 having an upper end and a lower end. As depicted in FIG. 1, a support base 11 affixed to the lower end of the support 10 provides static stability to the device whether or not it is loaded with the weight of a displayed item. The embodiment of the invention illustrated in FIG. 1 has a vertical support 10 in the form of a vertical post connected to a solid base 11. The base 11 can be of virtually any size, shape, or configuration, provided that it provides sufficient stability to the device.

In the embodiment of the invention illustrated in FIG. 2, the support base 11 is an open-centered bent wire that is coterminous with the vertical support 10. FIG. 2 shows the support base 11 formed from a semi-circularly-bent wire, though other shapes of a bent wire base are also feasible, such as polygons, star-shapes, heart shapes, spirals, etc. The only limitation on the configuration of the base 11 is that it be sufficiently sized and configured to provide static stability to the vertical support 10. In another embodiment of the invention (not illustrated), an open-centered circular wire base is welded to a wire vertical support, instead of a wire base/vertical support being formed from a continuous bent wire.

In another embodiment of the invention, the lower end of the support 10 is not connected to a base 11, but rather has a tapered end 12 suited for passage into a supporting media, such as dirt, potting soil, Styrofoam®, or other semi-solid material, as depicted in FIG. 3. Alternatively, the lower end of the support 10 may be completely straight, instead of tapered, which could be suitable for displaying the support in a vase of flowers (not illustrated).

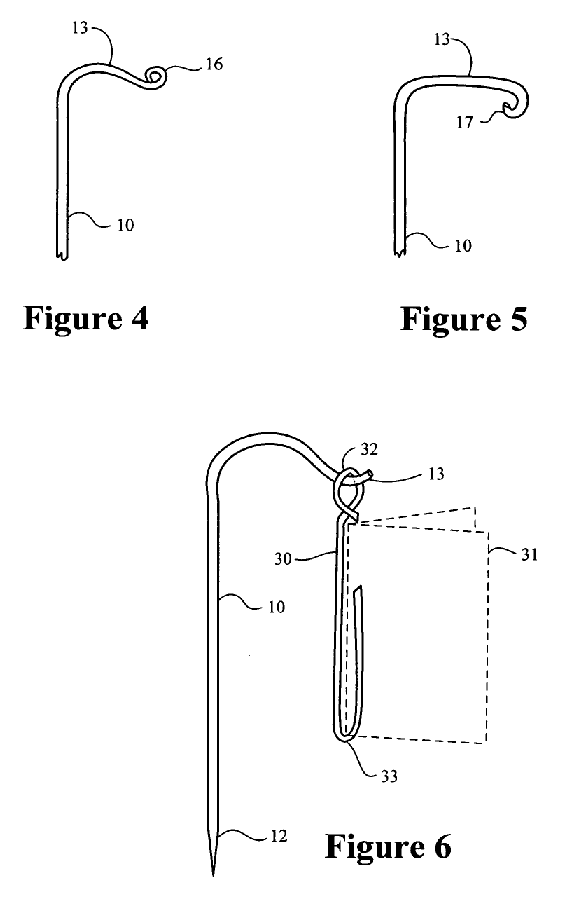

At the upper end of the vertical support 10 is located a suspension member 13 extending radially outwardly from the vertical support 10. FIG. 1 depicts a suspension member 13 formed from a bent wire. This suspension member 13 has an outward end 14 that is raised above the level of a dip or depression 15 in the suspension member. This configuration permits a hanger to be hung on the suspension member 13 such that the hanger rests in the dip 15. There are other configurations for the suspension member 13 that would work equally well, such as a loop at the end of the suspension member, as illustrated in FIG. 4, or a downwardly-projecting hook, as illustrated in FIG. 5.

FIG. 6 depicts one embodiment of a hanger means for securing the display item to the device during its display. In this embodiment, the hanger means comprises a bent wire frame 30 suitable for supporting the display item 31 from below while suspended from the suspension member 13. More specifically, the top end of the bent-wire frame 30 includes an upper loop 32 for suspending the entirety of the hanger means and any associated display item from the suspension member 13, as well as a main body with a pre-determined length. The length and size of the body of the frame 30 is pre-determined based upon the sizes of the intended display items. At the bottom end of the bent-wire frame 30 is included a supporting U-shaped loop 33 for receipt of a lower edge of the display item 31. The display item hanger 33 can be a U-shaped loop as shown in FIG. 6, or can be configured in any other shape suitable for securing the display item and suspending it from the hook 13. The frame 30 can be made from different types of wire, or, in other embodiments, could be made of plastic or other materials. Further, the hanger 33 could be configured to accommodate more than one card at the same time. In other embodiments of this configuration, more than one display item can be displayed on a single hook, which would result in a somewhat carousel effect of multiple display items.

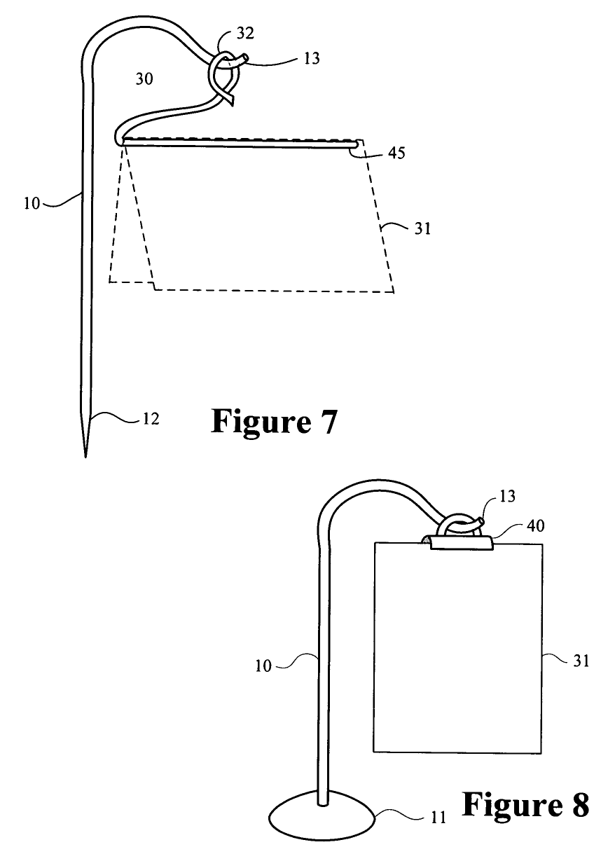

In an alternative embodiment of this invention, rather than a hanger 33 of the type depicted in FIG. 6, the hanger is configured where the display item 31 can be slipped over horizontal support member 45, as is depicted in FIG. 7. This embodiment allows for horizontal display of the display item. The horizontal support member may be a rigid support as shown in FIG. 7, or may instead be made of elastic material that is self-adjusting for the width of the display item.

Alternatively, the hanger means may comprise a spring-loaded clip member 40 for frictionally securing the display item 31, as shown in FIG. 8. The clip member can be a standard spring-loaded clip, friction clip, or any other clip capable of holding the display item. The clip member may be suspended from the suspension member 13 as depicted in FIG. 8. Alternatively, such clip member may be integrally formed in the suspension member.

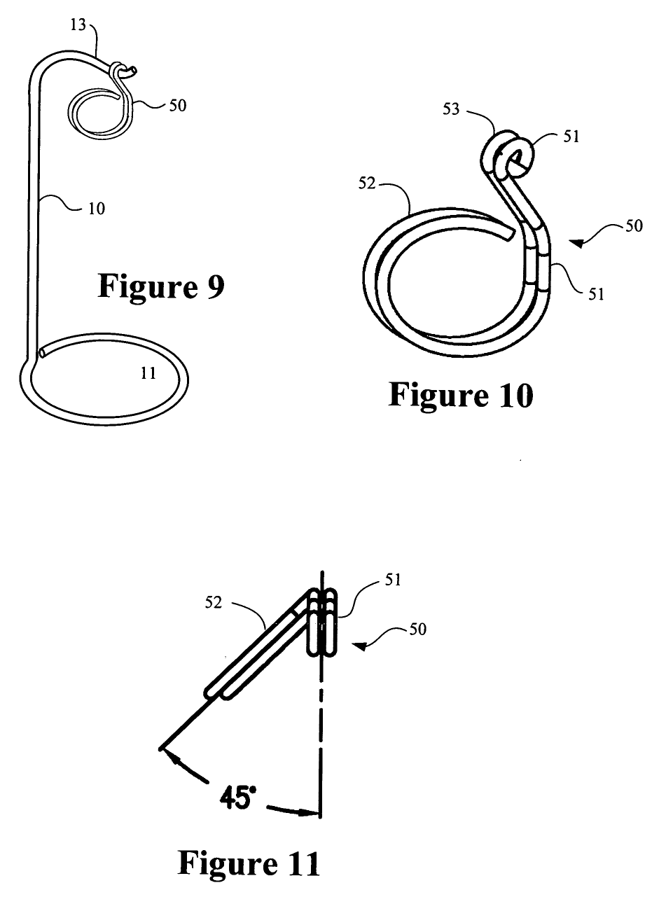

Another embodiment of the hanger means is the bent-wire clip 50 illustrated in FIG. 9. This clip 50 may be construction from a single continuous piece of wire 52 bent in the manner illustrated in FIG. 10. Wire that is 0.07 inch diameter stainless steel type 302 may be used for the clip 50, though other sizes and types of wire could alternatively be used. The wire 52 is bent at a center point near the upper portion 51 of the clip 50 to create two identical parallel curved shapes in close proximity to one another. Alternatively, two parallel wires joined at one end can be used. A loop 53 on the upper portion 51 of the clip 50 formed from the two parallel wires has a diameter greater than that of the suspension member so that it slides on the suspension member 13 for suspending a display item. The loop 53 may be circular or semi-circular or otherwise appropriately-shaped to slide onto the suspension member 13. The parallel wires that comprise the loop 53 aid in stabilizing the clip 50 and preventing a rocking action of the clip 50 along the axis of the suspension member 13. The lower portion 52 of this embodiment of the clip 50 comprises a semi-circle formed of the parallel bent wire, as illustrated in FIG. 10. Other embodiments of the clip 50 could use shapes other than a semi-circle for the lower portion 52 of the clip. A display item (not illustrated) can be inserted in between the two wires of the lower portion of the clip and will be frictionally held for display. In one embodiment of the invention, the loops are 0.3 inches apart to allow the card edge to slip in between the loops.

In one embodiment of the clip 50, the loop 53 is disposed in a plane approximately 45 degrees from the plane of the lower portion 52 of the clip, as illustrated in FIG. 11. This arrangement allows the display item to be held at an angle suitable for viewing the card. In one embodiment, the clip 50 is approximately 1.6 inches in length, though other dimensions could also be used.

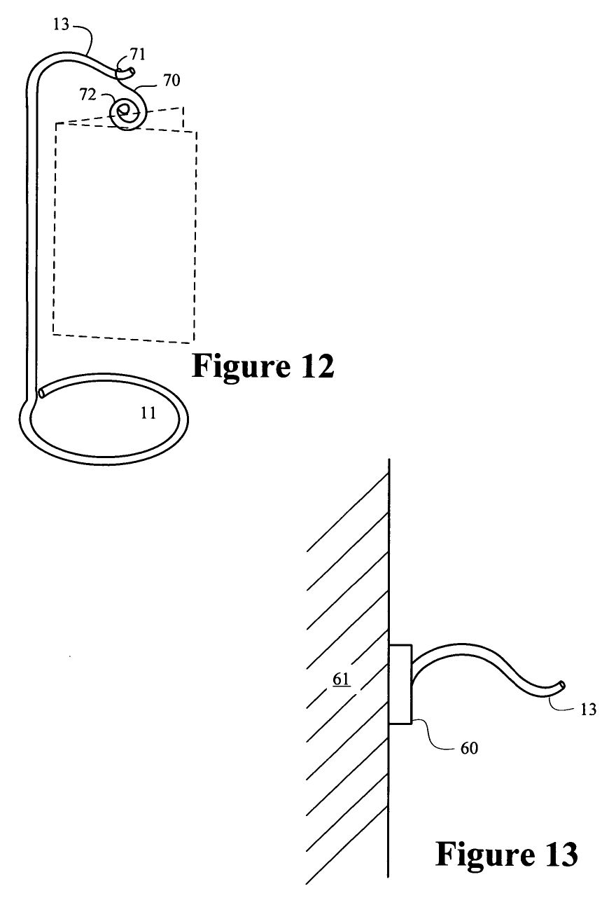

FIG. 12 illustrates a hanger means 70 of an alternative configuration. This hanger means 70 is comprised of a single strand of bent wire with an upper loop 71 for sliding over the suspension member 13 and a lower loop 72 that is a planar spiral, as illustrated in FIG. 12. The display item can be slipped between at least two of the wires in the spiral and be frictionally held between them.

In another embodiment of the invention, as illustrated in FIG. 13, the suspension means 13 is suspended from a base 60 that is attached to a typically vertical surface 61 by magnetic force (for attachment to metal surfaces such as refrigerators) by use of an adhesive such as glue or sticky tape.

It is to be understood that except as otherwise stated herein, no specific limitations of size or material composition of the present invention is made in the present application. As such, the present invention, in all of its potential embodiments, are not limited to any specific size, including, but not limited to, any diameter, length, radius, circumference, or angular displacement, or material composition suitable for the purposes of the present invention.

Although a preferred embodiment of the invention has been described using specific terms and devices, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of various other embodiments may be interchanged both in whole or in part. Therefore, the spirit and scope of the appended claims should not be limited to the description of the preferred version contained herein.

What is claimed is:

1. A device for displaying a card, comprising:
a vertical support;
a suspension member connected to the vertical support; and
a hanger means for attaching the card to the suspension member.

2. The device of claim 1, wherein the hanger means comprises a clip for frictionally affixing to a card.

3. The device of claim 1, wherein the hanger means comprises a bent wire for receiving a card.

4. The device of claim 1, further comprising a support base member onto which the vertical support is affixed.

5. The device of claim 1, wherein the vertical support is coterminous with the suspension member.

6. The device of claim 4, wherein the base member comprises a bent wire frame base.

7. The device of claim 4, wherein the base member, the vertical support, and the suspension member comprise coterminous bent wire.

8. The device of claim 1, wherein the vertical support has an upper and a lower end, and wherein the lower end comprises a stake for releasably securing the vertical support within a semi-solid medium.

9. The device of claim 1, wherein the suspension member extends generally vertically and has a depression for releasably retaining the hangar means.

10. The device of claim 1, wherein the suspension member has a free end formed in a loop for receiving the hanger means.

11. The device of claim 1, where the suspension member has a free end formed in a downward hook for receiving the hanger means.

12. The device of claim 1, wherein the hanger means comprises an upper portion and a lower portion, the upper portion comprising a loop for engaging with the free end of the suspension member, and the lower portion comprising a clip for frictionally affixing a card to the hanger means.

13. The device of claim 12, wherein the lower portion comprises a planar spiral comprised of wire and wherein the planar spiral accepts a card between at least two spiral rings.

14. The device of claim 12, wherein the lower portion comprises two parallel loops of wire closely spaced together to accept a card therebetween.

15. The device of claim 14, wherein the hanger means consists of a single continuous bent wire and wherein the loop comprises parallel segments of wire closely spaced together.

16. The device of claim 12, wherein a plane parallel to the lower portion is disposed at an angle to a plane parallel to the loop.

17. The device of claim 16, wherein the angle is about 45 degrees.

18. The device of claim 3, wherein the bent wire is configured with a horizontal bar for displaying a folded card in a horizontal orientation.

19. A device for displaying a card, comprising:
a suspension member;
a hanger means for attaching the card to the suspension member; and
a base for attaching the suspension member to a vertical surface.

20. A device for displaying an openable greeting card, comprising:
a vertical support;
a suspension member connected to the vertical support; and
a hanger means for attaching the card to a free end of the suspension member, wherein the hanger means comprises a clip for frictionally affixing to the upper rear edge of a greeting card such that the greeting card is displayable in an openable orientation.
